(19) United States
(12) Patent Application Publication
(10) Pub. No.: US 2025/0023420 A1
(43) Pub. Date: Jan. 16, 2025

(54) BASIC BODY FOR AN ELECTRIC MOTOR

(71) Applicant: Metabowerke GmbH, Nuertingen (DE)

(72) Inventors: Bernd Fleischmann, Weilheim (DE); Michael SCHMOHL, Ammerbuch (DE); Stefan BAUER, Oberboihingen (DE); Enrico FLOETE, Stuttgart (DE); Matthias Hiller, Altenriet (DE); Bernd WIESNER, Owen (DE); Thomas STENZEL, Ostfilderm (DE)

(73) Assignee: Metabowerke GmbH, Nuertingen (DE)

(21) Appl. No.: 18/791,033

(22) Filed: Jul. 31, 2024

Related U.S. Application Data
(63) Continuation of application No. 17/431,494, filed on Aug. 17, 2021, now Pat. No. 12,074,499.

(30) Foreign Application Priority Data
Feb. 22, 2019 (DE) 102019104557.6

(51) Int. Cl. H02K 5/22; H02K 3/50; H02K 5/173; H02K 11/33

(52) U.S. Cl. CPC H02K 5/225; H02K 3/50; H02K 5/1732; H02K 11/33; H02K 2203/03; H02K 2203/06

(57) ABSTRACT

The invention relates to a basic body for an electric motor, which comprises the following features: a substantially cylindrical outer wall, which forms a rotor space for receiving a rotor at least partially inside the outer wall and on which a winding can be mounted at least partially outside the latter; a laminated core which is held by the outer wall; a receiving space which serves to receive a printed circuit board or another component of the electric motor and which adjoins the rotor space; a partition wall separating the receiving space from the rotor space; at least one orienting device for positionally orienting the printed circuit board or the other component of the electric motor inside the receiving space; a receptacle for a cover which closes the rotor space, said receptacle being situated on the outer wall on the side of the rotor space opposite to the partition wall; and an inner wall, which adjoins the partition wall, for receiving a bearing for the rotor, said inner wall, together with the outer wall, creating the receiving space.

### CROSS-REFERENCE TO RELATED APPLICATION

This application is a continuation of U.S. patent application Ser. No. 17/431,494, filed on Aug. 17, 2021, which is a national phase of PCT patent application No. PCT/EP2020/054660 filed on Feb. 21, 2020, which claims priority to German Patent Application No. 10 2019 104 557.6 filed Feb. 22, 2019 and entitled “BASIC BODY FOR AN ELECTRIC MOTOR”, the entire contents of which are incorporated herein by reference.

### TECHNICAL FIELD

The disclosure relates to a main body for an electric motor, and to an electric motor.

DE 10 2007 020 534 A1 has disclosed a brushless electric motor with a stator and a rotor. In a manner known per se, the stator has a laminated core, in which the rotor which is fitted with permanent magnets can rotate.

DE 10 2011 088 518 A1 has disclosed a stator for an electric motor and a method for producing a stator of this type. Here, the stator is formed from two stator halves which are connected to one another.

### BACKGROUND

Brushless electric motors of this type which are equipped with rotors fitted with permanent magnets are being used more and more frequently even in electric hand-held power tools. Since the different types of electric hand-held power tools make completely different requirements on an electric motor, it is not possible or at least not appropriate for one and the same electric motor to be used for different types of electric hand-held power tools. In the past, this has led to a multiplicity of completely different electric motors, which substantially increases not only the production costs, but also the development costs for said electric motors.

### SUMMARY

It is an object of the present disclosure to provide a main body for an electric motor, which main body can be used equally in the case of electric motors which are equipped differently and are used for different purposes.

According to the disclosure, said object is achieved by way of the features which are mentioned in the appended claims.

The main body according to the disclosure is configured in the manner of a kit and can be used for a very wide variety of intended uses on account of its multiplicity of features which are adapted to a very wide variety of requirements which are made on an electric motor.

Here, the outer wall forms a rotor space, in which the rotor of the electric motor can be received. At the same time, the outer wall serves to receive a winding on its outer side, and to secure a laminated core which forms a part of the stator. The laminated core is preferably overmolded with the material of the outer wall, and is therefore integrated into said outer wall. With regard to the interconnection of the winding, both a star-shaped and a triangular interconnection and any desired other interconnection can be realized without problems. The same also applies to the commutation of the electric motor which is equipped with the main body, which commutation can be configured in a manner known per se as a block commutation, a sine commutation, an FOC or field oriented control, or as another known commutation type. Especially by way of a field oriented control, the degree of efficiency of the electric motor which is equipped with the main body according to the disclosure can in part be increased considerably.

According to the disclosure, the rotor space is adjoined by a receiving space, in which a printed circuit board or another component of the electric motor can be received. It goes without saying that it is only possible and not necessarily required for a printed circuit board or another component of the electric motor to be received in the receiving space, for which reason the main body (as indicated above) can be used for a very wide variety of embodiments of electric motors.

The receiving space is divided from the rotor space by means of a dividing wall. Here, the dividing wall represents a decoupling of the printed circuit board which can be received in the receiving space with respect to the rotor, in particular with respect to the permanent magnets which are arranged on said rotor. In this way, the printed circuit board is protected against electrostatic voltages or an electrostatic charge. Here, the position of the printed circuit board or of the other component which is received in the receiving space can be oriented by way of the orienting device which is situated within the receiving space.

If, in the case of certain applications, for example in the case of electric hand-held power tools which are subjected to pronounced contamination, it is required for the rotor space to be encapsulated, a cover can be attached on the receptacle according to the disclosure for a cover of this type, which receptacle is situated on the outer wall on that side of the rotor space which lies opposite the dividing wall, in order to prevent a contamination and possibly damage of the electric motor.

Finally, the inner wall which adjoins the dividing wall makes it possible to receive a bearing, in order to make suitable mounting of the rotor or the rotor shaft on the main body possible.

The main body according to the disclosure can therefore be used universally for a very wide variety of types and designs of electric motors, it being possible for said main body to be adapted specifically to the respective requirements. One particular advantage of the solution according to the disclosure consists in its high flexibility, since the main body can be produced by way of different, sequential method steps, it being possible for certain method steps to be omitted and others to be performed depending on the desired embodiment of the electric motor which has the main body.

It can be provided in one very advantageous development of the disclosure that the dividing wall has an opening for leading through a rotor shaft. As a result, the rotor shaft which is connected to the rotor can be received in the main body in a very simple way, and can optionally be mounted on said main body.

It can be provided in a further very advantageous development of the disclosure that the laminated core forms a plurality of teeth which project to the outside from the outer wall and on which the winding can be received. As a result of the teeth of the laminated core which project from the outer wall to the outside, the winding can be attached to the main body in a very simple way, with the result that the electric motor which has the main body according to the disclosure can be manufactured very inexpensively.

In order to simplify the positioning of the rotor within the main body, it can be provided in a further advantageous refinement of the disclosure that the opening for leading through the rotor in the dividing wall has a non-round cross section.

If, in a further advantageous refinement of the disclosure, at least two webs for supporting the printed circuit board or the other component of the electric motor are arranged on the dividing wall, the printed circuit board or another component can be supported reliably on the main body. In addition, the webs ensure a tolerance compensation and spacing of the printed circuit board from the dividing wall, with the result that electronic elements can be attached on both sides of the printed circuit board.

A very simple positional orientation of the printed circuit board or the other component of the electric motor results if the at least one orienting device has at least one projection which is arranged on at least one of the webs for engagement into an opening of the printed circuit board or of the other component of the electric motor.

In order for it to be possible for the winding to be arranged at the desired positions, it can be provided, furthermore, that the outer wall has a plurality of cutouts for leading through the winding.

Manufacturing of the main body can be simplified considerably if the receptacle for the cover which closes the rotor space is configured as a peripheral cutout on the inner circumference of the outer wall.

In order for it to be possible for a possibly provided cover which closes the rotor space to be oriented exactly, it can be provided, furthermore, that the receptacle for the cover which closes the rotor space has at least one slot for the positional orientation of the cover.

If, in a further advantageous refinement of the disclosure, the receiving space is formed by way of a peripheral depression between the outer wall and the inner wall, and serves to receive connector wires for the interconnection of the winding, this results in highly satisfactory protection for said connector wires.

In order to make a simple accommodation of a position transmitter for the determination of the angular position of the rotor possible, furthermore, an axial extension for a position transmitter can be provided on that side of the dividing wall which faces away from the rotor space.

Some embodiments of the disclosure relate to an electric motor with a rotor, a winding and a main body.

An electric motor of this type can be used in a highly universal manner and, in particular, for a wide variety of electric hand-held power tools, by said electric motor being equipped with the respectively required or desired components or elements. In particular, the electric motor can be fed both by the power network and by a rechargeable battery, it also being possible in both cases for the safety spacings which are required for insulation for high-voltage applications to be maintained. Furthermore, the electric motor can be supplied with current via the power network or by means of a battery or a rechargeable battery. Moreover, it is advantageously possible for the electric motor to be operated by way of a wide variety of electronic open-loop and/or closed-loop controllers.

It can be provided in one advantageous development of the electric motor that the at least one projection for fastening the printed circuit board or the other component of the electric motor is staked. This is a very simple possibility for fixing the printed circuit board or another component of the electric motor.

A likewise simple and insensitive electric connection of the winding to a controller of the electric motor results if connector wires which serve for the interconnection of the winding are received via respective plug terminals in a plug housing, it being possible for the plug housing to be connected to a plug receptacle.

If, here, the plug housing can be connected by means of a snap-in connection to the plug receptacle, this results in very simple assembly of said components to one another.

In addition, it is to be noted that terms such as “comprising”, “have” or “with” do not rule out any further features or steps. Furthermore, terms such as “a” or “the” which indicate a singular number of steps or features do not rule out a plural number of features or steps, and vice versa.

Further features and advantages of the disclosure result from the following description of one exemplary embodiment of the disclosure. The figures show a plurality of features of the disclosure in combination with one another. It goes without saying that a person skilled in the art is also capable of considering them separately from one another, however, and possibly combining them to form further appropriate sub-combinations, without having to exercise an inventive step for this purpose.

### BRIEF DESCRIPTION OF THE DRAWINGS

In the figures, diagrammatically:

FIG. 1 shows a plan view of a main body according to the disclosure for an electric motor,

FIG. 2 shows a view of the main body in accordance with the arrow II from FIG. 1,

FIG. 3 shows a view of the main body in accordance with the arrow III from FIG. 2,

FIG. 4 shows a perspective view of an electric motor according to the disclosure with a rotor, a winding and a main body according to the disclosure,

FIG. 5 shows a further perspective view of the electric motor from FIG. 4,

FIG. 6 shows a side view of the electric motor according to FIGS. 4 and 5,

FIG. 7 shows a view of the electric motor in accordance with the arrow VII from FIG. 6,

FIG. 8 shows a view of the electric motor in accordance with the arrow VIII from FIG. 6,

FIG. 9 shows a section through the electric motor in accordance with the line IX-IX from FIG. 6,

FIG. 10 shows a section through the electric motor in accordance with the line X-X from FIG. 6,

FIG. 11 shows a side view of a further embodiment of the main body according to the disclosure for the electric motor,

FIG. 12 shows a view in accordance with the arrow XII from FIG. 11,

FIG. 13 shows a perspective view of the main body of FIGS. 11 and 12,

FIG. 14 shows a section according to the line XIV-XIV from FIG. 12,

FIG. 15 shows a further illustration of the main body according to FIGS. 11 to 14,

FIG. 16 shows a part of an electric motor with the main body from FIG. 15,

FIG. 17 shows the part of the electric motor from FIG. 16 with further attachment components,

FIG. 18 shows a further embodiment of the electric motor according to the disclosure,

FIG. 19 shows a view of a component which can be connected to the electric motor from FIG. 18, and

FIG. 20 shows a further view of the electric motor from FIG. 18 and of the component from FIG. 19.

### DETAILED DESCRIPTION

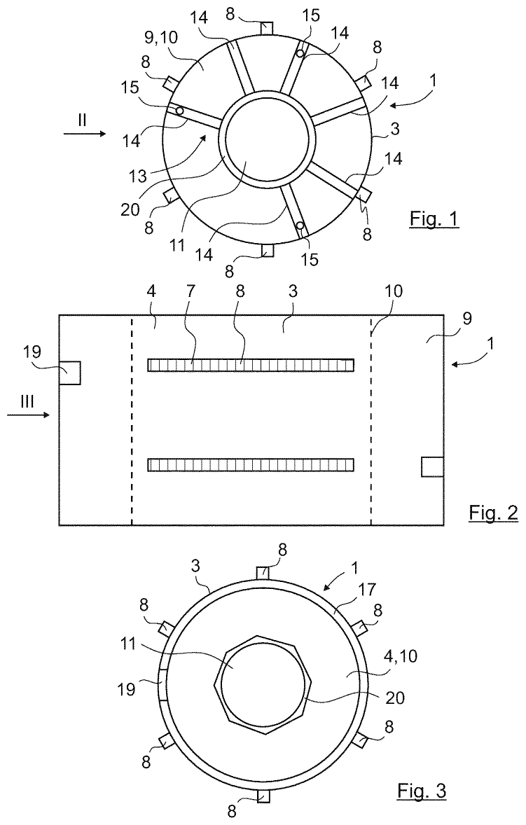

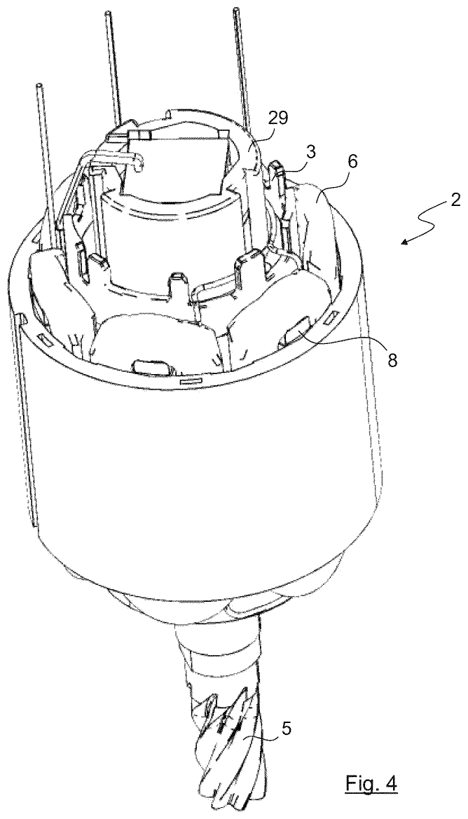

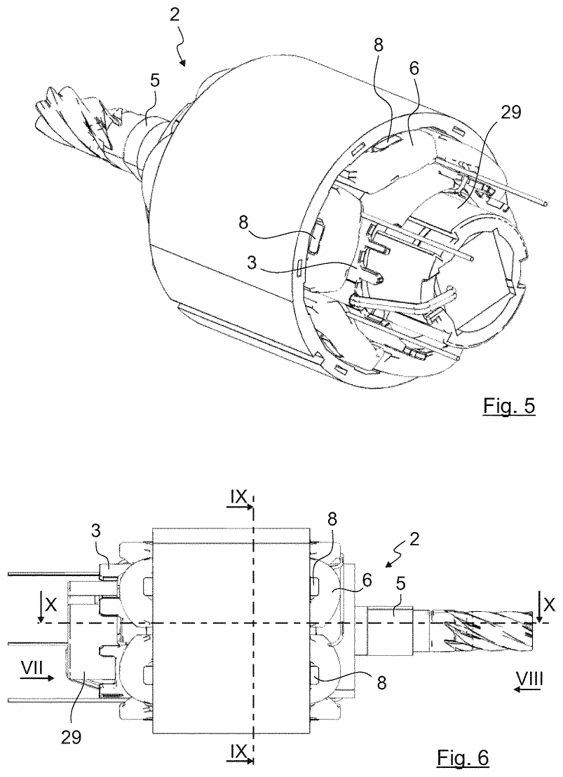

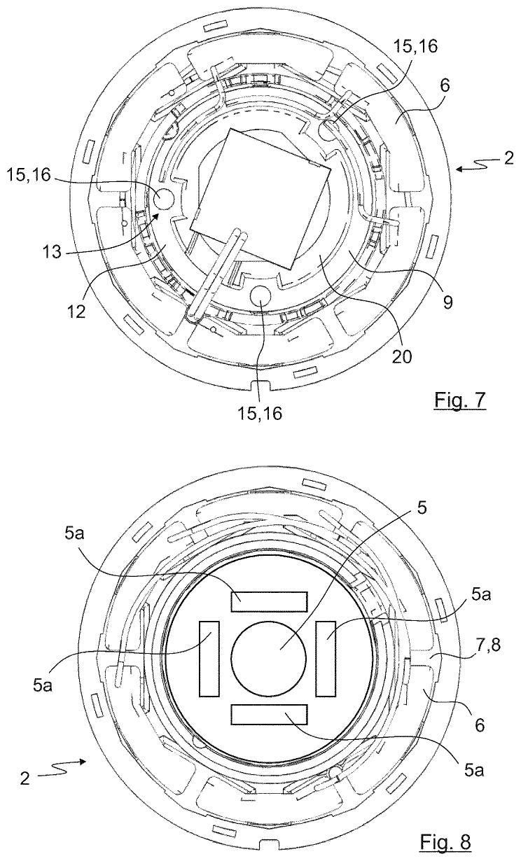

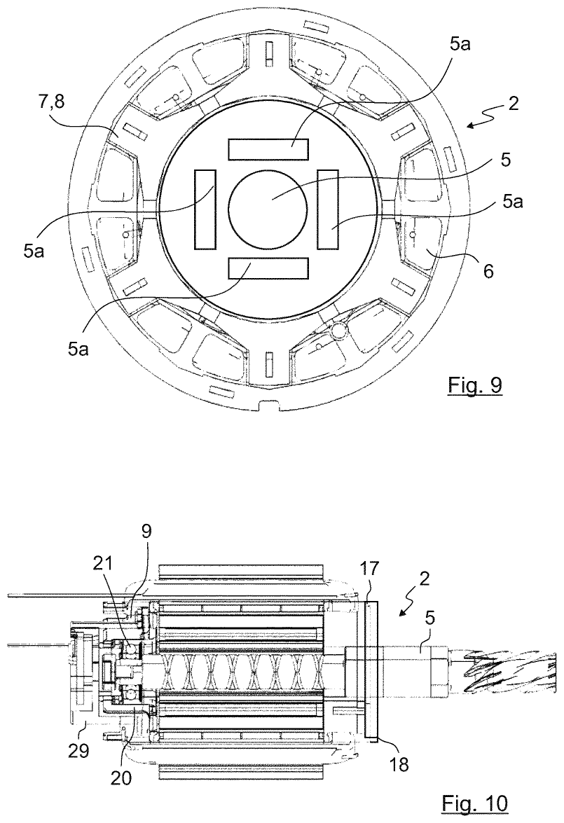

FIGS. 1, 2 and 3 show a highly diagrammatic illustration of a main body 1 for an electric motor 2 which is shown in greater detail in FIGS. 4 to 11. The electric motor 2 is provided, in particular, for use in an electric hand-held power tool, for example an angle grinder, a power drill, a saw or another electric hand-held power tool. In order for it to be possible for the main body 1 to be used in the case of electric motors 2 for a very wide variety of applications, said main body 1 is of highly universal configuration, as described in detail in the following text.

The main body 1 has a substantially cylindrical outer wall 3 which forms a rotor space 4 for receiving a rotor 5 (shown, for example, in FIG. 4) of the electric motor 2. The electric motor 2 is configured as a brushless electric motor, in the case of which the rotor 5 has a plurality of permanent magnets 5a or is fitted with the permanent magnets 5a. Here, as can be seen clearly, for example, in the section of FIG. 11, the rotor 5 which has a rotor shaft 5b in a manner known per se is arranged at least partially within the rotor space 4 or within the outer wall 3.

Furthermore, a coil or winding 6 (shown, for example, in FIG. 4) can be attached to the outer wall 3 at least partially outside the outer wall 3. Moreover, the outer wall 3 serves to secure a laminated core 7 which is formed in a manner known per se from a multiplicity of individual laminations which are stacked above one another. In the present case, the laminated core 7 is overmolded with the material of the outer wall 3, preferably a suitable plastic material, and is integrated in this way into the outer wall 3 and therefore into the main body 1. With the winding or the windings 6 and the laminated core 7, the main body 1 forms a stator for the electric motor 2. The effect which results by way of the energization of the winding 6, namely the rotation of the rotor 5 within the winding 6 or within the stator, is known per se and will therefore not be described in greater detail herein.

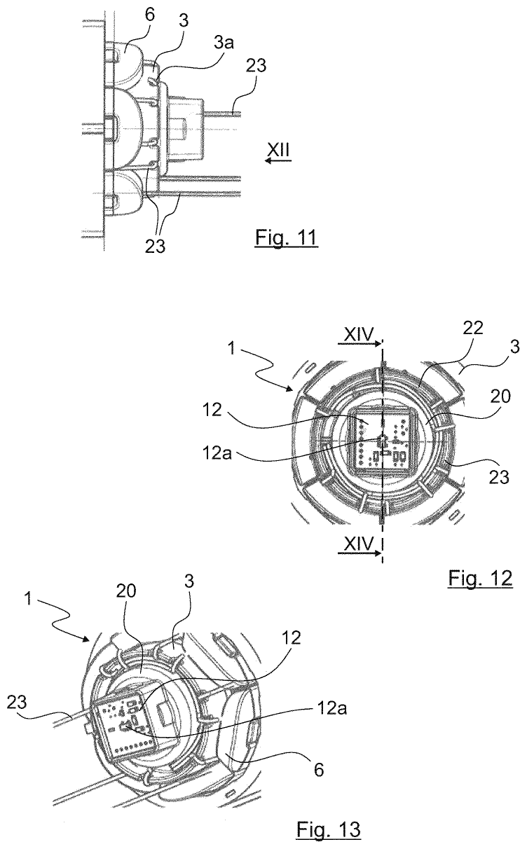

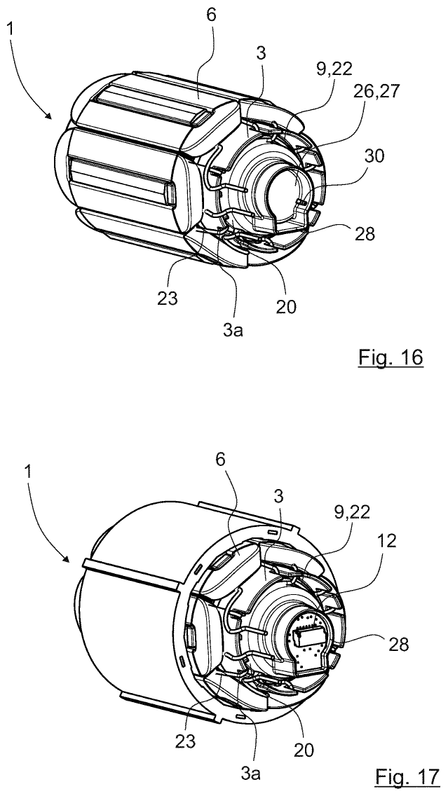

It can be seen in FIG. 2 that the laminated core 7 forms a plurality of (in the present case, six) teeth 8 which project from the outer wall 3 to the outside and on which the winding 6 can be received. Here, one of the windings 6 preferably runs around each tooth 8. The winding 6 can be wound, for example, on a one-dimensionally arranged carrier element (not shown). In order to attach the winding 6 to the main body 1, said carrier element can then be deformed, in order to produce the three-dimensional contour of the winding 6. To this end, the carrier element can have, for example, joints or the like. Here, the laminations which form the laminated core 7 are of substantially annular configuration, each of the individual laminations having the total of six teeth 8 on its outer circumference. Moreover, the outer wall 3 has a plurality of cutouts 3a which serve to lead through the winding 6 or an interconnection (shown in FIGS. 12 to 14 and 16 to 20) for the winding 6.

The rotor space 4 is adjoined by a receiving space 9 which is divided from the rotor space 4 by means of a dividing wall 10 which is formed by way of a planar surface and has an opening 11 for leading through the rotor 5. With the exception of the opening 11 which serves for leading through the rotor 5 or the rotor shaft 5b, the dividing wall 10 is completely closed and therefore seals the rotor space 4. An additional seal element can possibly also be used in this region. The receiving space 9 serves to receive an annular printed circuit board 12 (shown, for example, in FIG. 7), to which the wide variety of electronic components which serve to control the electric motor 2 can be attached. The printed circuit board 12 preferably has a sensor 12a (shown, for example, in FIGS. 12 and 13), in particular a Hall sensor which is used in the case of a block commutation of the electric motor 2, or a Hall PCBA, or is fitted therewith. A sensor 12a of this type can serve, for example, to determine the position of the rotor 5 as exactly as possible. To this end, it can interact with corresponding magnets which are arranged on the rotor 5. It is also possible, however, to use temperature sensors, for example. Instead of the printed circuit board 12, another component (not shown in greater detail) of the electric motor 2 can also be received in the receiving space 9. Said component can likewise be provided for receiving or securing a sensor for the electric motor 2. The abovementioned cutouts 3a in the outer wall 3 are situated in that region of the outer wall 3 which surrounds the receiving space 9. An interconnection (shown in FIGS. 12, 13 and 14) for the winding 6 can be situated above the printed circuit board 12, that is to say on that side of the printed circuit board 12 which faces away from the dividing wall 10. To this end, the outer wall 3 has a corresponding length in this region, that is to say the receiving space 9 is deep enough to receive both the printed circuit board 12 and the interconnection for the winding 6.

An orienting device 13 which serves for positional orientation of the angular position of the printed circuit board 12 or the abovementioned other component of the electric motor 2 within the receiving space 9 and therefore with respect to the winding 6 or the rotor 5 is situated on the dividing wall 10. Furthermore, at least two (in the present case, a total of six) webs 14 for supporting the printed circuit board 12 or the other component of the electric motor 2 are arranged on the dividing wall 10. In its mounted state, the printed circuit board 12 lies on the webs 14, with the result that components which are situated on the underside of the printed circuit board 12 are also spaced apart from the dividing wall 10. It goes without saying that a completely different number of webs 14 can also be provided. The height of the webs 14 can be selected in such a way that a desired spacing of the printed circuit board 12 from the rotor 5 which is situated on the other side of the dividing wall 10 can be set, in order to ensure sufficient coupling between possible sensors which are situated on the printed circuit board 12 and the rotor 5 and therefore a correct function of said sensors.

The orienting device 13 has at least one (in the present case, three) projections 15 which are arranged on at least one of the webs 14 (in the present case, on three different webs 14) for engaging into a bore 16 of the printed circuit board 12 or of the other component of the electric motor 2. For fastening or fixing of the printed circuit board 12 to the main body 1, the at least one projection 15 or the plurality of projections 15 can be staked after arranging of the printed circuit board 12 within the receiving space 9.

Moreover, a receptacle 17 is provided on that side of the rotor space 4 which lies opposite the dividing wall 10, which receptacle 17 serves to receive a cover 18 which closes the rotor space 4 and therefore protects it against the penetration of dust or other contaminants. Here, the receptacle 17 for the cover 18 which closes the rotor space 4 is configured as a peripheral cutout on the inner circumference of the outer wall 3. The receptacle 17 for the cover 18 is therefore provided on that side of the main body 1 which lies opposite the cutouts 3a. In addition, the receptacle 17 for the cover 18 has at least one slot 19 for the positional orientation of the cover 18, into which slot 19 a projection (not shown) of the cover 18 can engage. Moreover, the cover 18 can serve to receive a bearing (not shown) for mounting the rotor 5.

The dividing wall 10 is adjoined by a substantially cylindrical inner wall 20 which serves to receive a bearing 21 for the rotor 5 and produces the receiving space 9 together with the outer wall 3. The bearing 21 can be pressed onto the rotor 5.

At the same time, the inner wall 20 forms a centering means for the printed circuit board 12. The opening 11 for leading through the rotor 5, which opening 11 is situated in the dividing wall 10 and is surrounded by the inner wall 20, has a non-round cross section, in the present case an octagon.

The outer wall 1, the dividing wall 10, the webs 14, the projections 15 and the inner wall 20 of the main body 1 preferably consist of a suitable plastic material, and can be produced by means of injection molding. For this reason and on account of its shape, the main body 1 can also be called an overmolded tooth star.

Here, the outer wall 1, the dividing wall 10, the webs 14, the projections 15 and the inner wall 20 are preferably configured in one piece with one another, and are produced, in particular, by means of a single injection molding process. Here, on account of the above-described, highly universal configuration of the main body 1, only a single injection molding die is in principle required. As a result of the above-described non-round cross section of the opening 11, said injection molding die can be of very exact configuration in the region which produces the opening 11, as a result of which likewise exact, central positioning of the rotor 5 within the opening 11 is possible. As a result of the molding of the inner wall 20 which receives the bearing 21 for the rotor 5 onto the dividing wall 10, very simple sealing is achieved in this region, inter alia satisfactory sealing of the rotor space 4, without an additional cover, a casting compound or the like being required.

FIGS. 11 to 17 show a further embodiment of the main body 1 or of the electric motor 2 which is equipped therewith, which embodiment coincides in large parts with the above-described embodiment. It can be seen here that the receiving space 9 is formed by way of a peripheral depression 22 between the outer wall 3 and the inner wall 20. The peripheral depression 22 therefore corresponds to the receiving space 9. The peripheral depression 22 serves to receive connector wires 23 which in turn can be used for an interconnection of the winding 6. As a result, the connector wires 23 can be laid reliably and can be protected against abrasion. After the interconnection of the winding 6, the connector wires 23 can be potted with a potting compound (not shown). Here, the connector wires 23 run through the cutouts 3a which are provided in the outer wall 3. Furthermore, additional holding devices for holding the connector wires 23 can be dispensed with as a result of this accommodation. The depression 22 or, in this case, the receiving space 9 between the outer wall 3 and the inner wall 20 can also be called a labyrinth, since it prevents the penetration of dirt and the like into the region, in which the connector wires 23 for the winding 6 are situated. In principle, the winding 6 can be interconnected by means of a star-shaped or a triangular interconnection or any other interconnection.

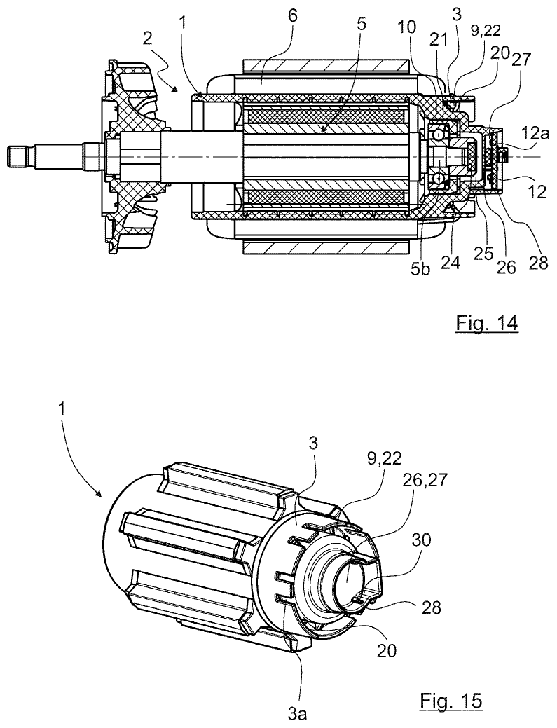

It can be seen in the section of FIG. 14 that a position transmitter 24 is attached to the rotor shaft 5b. In order to receive the position transmitter 24, the inner wall 20 is adjoined by an axial extension 25. The axial extension 25 is closed off by way of a closure wall 26 which is configured in one piece with the main body 1. At the same time, the closure wall 26 forms a bottom of a further space 27, in which, in the present case, the printed circuit board 12 with the sensor 12a is arranged. In the present case, the sensor 12a is a position sensor which interacts with the position transmitter 24. The space 27 is surrounded by a circumferential wall 28 and is open on the side which faces away from the closure wall 26. In the case of the embodiment which is described with reference to FIGS. 1 to 10, the space 27 is formed by way of an end cap 29 which can be staked, clipped or connected in some other way to the main body 1.

It can be seen in FIG. 15 that, on its inner side, the circumferential wall 28 has a plurality of projections 30, by way of which positioning of the printed circuit board 12 is simplified.

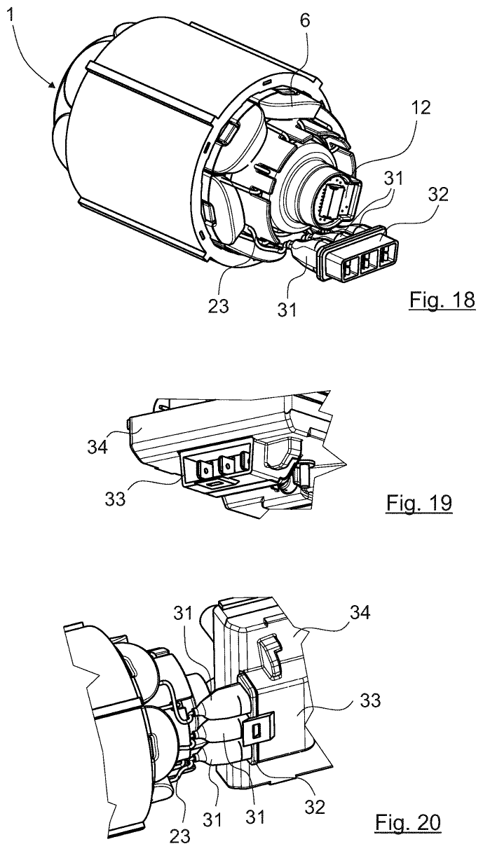

FIGS. 18 to 20 show a further refinement of the electric motor 1. Here, the connector wires 23 which serve for the interconnection of the winding 6 are connected to respective plug terminals 31 which are received jointly in a plug housing 32. The plug housing 32 serves for plugging into a plug receptacle 33 which is formed directly onto an electronics cup 34. In a way which is not shown, plug-in tongues which are cast onto a circuit board in a way which is likewise not shown are provided in the plug receptacle 33. As a result, plugging of individual wires can be dispensed with, since all the connector wires 23 of the windings 6 can be connected by means of the one plug housing 32 to the controller for the electric motor 2, which controller is received in the electronics cup 34 in a way which is not shown. Furthermore, the dust resistance of the electric motor 2 with its controller is improved in this way.

The plug housing 32 and the plug receptacle 33 are in each case plastic components which can be produced in a simple way. In the present case, the plug housing 32 is connected to the plug receptacle 33 by means of a snap-in connection. In a way which is not shown, the plug housing 31 can be connected fixedly to the main body 1. In this way, during the assembly of the electric motor 2, its electric connection could take place at the same time.

1. (canceled)

2. A main body for an electric motor comprising:
an outer wall having a substantially cylindrical outer wall portion forming a rotor space configured to at least partially receiving a rotor;
a winding at least partially attached to an outside portion of the outer wall, wherein the winding at least partially forms a winding cylinder;
a laminated core held by the outer wall; and
a bearing located within the winding cylinder, wherein a shaft of the rotor is receivable in the bearing.

3. The main body of claim 2, wherein a portion of the winding extends past the substantially cylindrical outer wall portion and wherein the bearing is located within the winding cylinder that extends past the substantially cylindrical outer wall portion.

4. The main body of claim 2, wherein the laminated core includes a plurality of teeth for receiving the winding, wherein the plurality of teeth project to the outside from the outer wall.

5. The main body of claim 2, further comprising a dividing wall attached to an end of the substantially cylindrical outer wall portion, wherein the dividing wall has an opening configured to receive a shaft of the rotor.

6. The main body of claim 5, wherein the bearing is received in the dividing wall.

7. The main body of claim 5, wherein the opening in the dividing wall has a non-round cross section.

8. The main body of claim 5, further comprising at least two webs arranged on the dividing wall and configured to support a printed circuit board or other components of the electric motor.

9. The main body of claim 5, further comprising an axial extension configured to receive a position transmitter attached to the rotor, wherein the axial extension is provided on a side of the dividing wall facing away from the rotor space, and wherein the axial extension and the dividing wall at least partially isolate the position transmitter from the exterior of the main body.

10. The main body of claim 9, further comprising a rotor received in the rotor space, wherein an end of the rotor extends into the axial extension, and wherein the position transmitter is attached to the end of the rotor.

11. The main body of claim 2, wherein the laminated core is overmolded with a material of the outer wall.

12. The main body of claim 2, wherein a receiving space is formed by way of a peripheral depression between the outer wall and an inner wall, and wherein the receiving space receives one or more connector wires for interconnection of the winding.

13. An electric motor comprising:
a rotor having an end;
a winding; and
a main body comprising:
a substantially cylindrical outer wall forming a rotor space, wherein the rotor is at least partially received in the rotor space, and wherein the winding is at least partially attached to an outside of the substantially cylindrical outer wall;
a laminated core held by the outer wall;
a dividing wall, wherein the dividing wall at least partially seals the rotor space;
a position transmitter attached to the end of the rotor;
an axial extension provided on a side of the dividing wall facing away from the rotor space, wherein the end of the rotor is received in the axial extension; and
a closure wall, wherein the closure wall encapsulates the position transmitter.

14. The electric motor of claim 13, further comprising a sensor configured to interact with the position transmitter to sense the position of the rotor.

15. The electric motor of claim 14, further comprising a space isolated from the exterior of the electric motor, wherein the sensor is located in the space.

16. The electric motor of claim 13, wherein the winding at least partially forms a winding cylinder, and further comprising a bearing located within the winding cylinder, wherein a shaft of the rotor is received in the bearing and rotates by way of the bearing.

17. The electric motor of claim 16, wherein a portion of the winding extends past a substantially cylindrical portion of the outer wall and wherein the bearing is located within the winding cylinder that extends past the substantially cylindrical portion of the outer wall.

18. The electric motor of claim 13, wherein the laminated core is overmolded with a material of the outer wall.

19. The electric motor of claim 13, further comprising a receiving space formed by way of a peripheral depression between the outer wall and an inner wall, and wherein the receiving space receives one or more connector wires for interconnection of the winding.

20. The electric motor of claim 13, further comprising at least two webs arranged on the dividing wall and configured to support a printed circuit board or other components of the electric motor.

21. A main body for an electric motor comprising:
an outer wall having a substantially cylindrical outer wall portion forming a rotor space configured to at least partially receiving a rotor;
a winding at least partially attached to an outside portion of the outer wall; and
a laminated core held by the outer wall, wherein the laminated core is overmolded with a material of the outer wall.
